(19) United States
(12) Patent Application Publication
(10) Pub. No.: US 2021/0206556 A1
(43) Pub. Date: Jul. 8, 2021

(54) PRODUCT PACKAGING

(71) Applicant: Conopco, Inc., d/b/a UNILEVER, Englewood Cliffs, NJ (US)

(72) Inventors: Oliver James BOULTON, Chester (GB); Nurani Dharmaraj Krishnaprakash IYER, Kandivili West (IN)

(21) Appl. No.: 16/755,466

(22) PCT Filed: Oct. 23, 2018
(86) PCT No.: PCT/EP2018/079060

§ 371 Date: Apr. 10, 2020

(30) Foreign Application Priority Data
Oct. 26, 2017 (EP) 17198515.3

(51) Int. Cl. B65D 75/32; A61J 1/03

(52) U.S. Cl. CPC B65D 75/327; B65D 75/527; A61J 1/035

(57) ABSTRACT

A method of collecting packaging material including a chain of blister packs is characterized in that after use of a product contained in a blister, a chain of emptied blister packs forms a concertina fold, wherein all the blisters are of the same shape in the chain of blister packs such that the repeating units of the chain of blister packs are linked in such a way that their cavities fit into each other when stacking in an alternating way.

### FIELD OF THE INVENTION

The present invention is in field of packaging; in particular it relates to packaging of FMCG products.

### BACKGROUND OF THE INVENTION

The concept of sachet packs for FMCG products goes back a long time. The idea originated in the Asian markets as a way of making FMCG products available and affordable to the common man.

Sachets are great options for consumers who want to use a specific product but are against the idea of buying full-size packs due to reasons such as price constraints or consumer uncertainty for first-time buyers. Sachets are also known to help in driving consumption of products that do not have high penetration levels.

Sachet packaging, normally made of a thin film of plastic and aluminum in a sandwich laminate form, has captured many of the developing and under developed market segments and allowed the low-income communities to enjoy quality products such as shampoos, toothpastes, lotions, condiments, even ready-to-eat food and drinking water, which are not viable with normal bottle and container packaging.

While the sachets have brought better quality products to low-income communities, they have also become a waste challenge. Community waste volumes are projected to grow worldwide as adoption of these sachet products increases.

Because there is no economic incentive to collect used sachets that have been improperly dumped, they are not picked up whilst the plastic bottles are since they fetch a small amount of money if collected and returned.

Thus, waste sustainability is fast becoming an issue in countries in Asia, threatening to overrun landfills and create new ones from what are otherwise beautiful landscapes and endangering the water supply by contamination.

Biodegradable and recyclable sachets are available, but these are more expensive and affect the sensitive low-product price points which is the main justification for offering the product in sachet form in the first place.

Packaging with the film of plastic and aluminium is essential for sachets especially when used for packaging liquid products in order to avoid any leakage but are not recyclable or biodegradable. Hence, a need remains for packaging that can be easily collected after the use of the product and preferably made of cheap biodegradable or recyclable materials.

The art already provides teaching for easy and efficient folding of filled blister packs.

WO 2007/067054 relates to a blister pack for objects such as tablets, pills or capsultes, comprises a plurality of accomodation units (1) which are interconnected along lines of weakness (2). Each accomodation unit (1) is provided with a piercable base sheet (5) and a cap part (4) which is fixed to the base sheet (5), an accommodation space for accommodating an object (6) being formed between the base sheet (5) and the cap part (4) of each accommodation unit (1), characterised in that the blister pack comprises a plurality of connecting parts (3), each of which is connected by way of two respective Hines of weakness (2) to at least one accommodation unit (1) in each case.

FR2610300A relates to a ‘blister’ pack constituted by two sheets joined and fixed to one another, namely a first sheet made of relatively rigid plastic material, locally thermoformed in order to constitute cells on a same side of the sheet and a second relatively flexible sheet extending over the openings of the cells. The pack is characterised in that the parts (4) of the first relatively rigid sheet (1) which extend between the adjacent cells (3) have lines of weakness (5,6) extending between two opposite parallel edges of the pack and making it possible to separate each cell (3) at will, together with the piece of second covering sheet (1) covering it, from the rest of the cells.

However, while WO2007/067054 and FR2610300A provide teaching for folding product filled blister packs, a solution for compactly folding spent blister packs remains to be desired.

It is therefore an object of the present invention is to provide a packaging which can be easily collected after the use of the product.

It is another object of the present invention to provide a packaging which encourages consumers to pick it up when seen littered.

It is yet another object of the present invention to provide a packaging model which eliminates the need of using plastic and aluminium.

It is yet another object of the present invention to provide a packaging model which uses recyclable and/or biodegradable material for packaging.

Surprisingly, it is found that a chain of emptied blister packs in the form of a compact concertina, wherein all the blisters (5) are of the same shape in a chain (1) such that the repeating units of the blister chain are linked in such a way that their cavities fit into each other when stacking in an alternating way, provide for compact waste collection.

### SUMMARY OF THE INVENTION

Accordingly, in a first aspect, the present invention provides a method of collecting packaging material comprising a chain of blister packs (1) characterized in that after use of the product (P) contained in the blister, the chain of emptied blister packs form a concertina fold, wherein all the blister (5) are of the same shape in the chain (1) such that the repeating units of the blister chain are linked in such a way that their cavities fit into each other when stacking in an alternating way.

In the context of the present invention, the reference to “blister pack” typically means pre-formed packaging used for small consumer goods, foods, and for pharmaceuticals comprising a cavity or pocket (blister) made from a formable web.

In the context of the present invention, the reference to “concertina fold” typically means to fold, crush together or collapse in the manner of a concertina.

In the context of the present invention, the reference to “chain” typically means a series of blister packs connected one after another.

In the context of the present invention, the reference to “FMGC” typically means fast moving consumer goods.

In the context of the present invention, the reference to “line of weakness” typically means the line along which the blister packs can be separated and/or folded, preferably without the use of a tool, more preferably by hand.

In the context of the present invention, the reference to empty/emptied blister packs typically means the product in the blisters are used.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

In a first aspect, the present invention relates to a method of collecting packaging material comprising a chain of blister packs (1) characterized in that after use of the product (P) contained in the blister, the chain of emptied blister packs form a concertina fold, wherein all the blisters (5) are of the same shape in the chain (1) such that the repeating units of the blister chain are linked in such a way that their cavities fit into each other when stacking in an alternating way.

Preferably the chain is folded to form the concertina fold.

The blister packs (2) are arranged in an alternating manner in the chain.

### Chain of Blister Packs

The chain of blister packs (1) according to the present invention can be a single chain of blister packs or multiple chains attached to each other. The chain is preferably a hanging chain.

The blister packs (2) of the present invention are arranged in an alternating manner wherein all the odd blisters face one side and the even blisters face the other side in the chain.

Each blister pack (2) is provided with a blister (5) and a backing.

The blisters (5) can be made of any known materials commercially available for forming web (blisters) in blister packs. The blisters (5) are preferably made of biodegradable or recyclable plastic. Suitable biodegradable or recyclable plastic include machine-direction orientation (MDO) films, in particular MDO films made from polyethylene, BOPP/PE films, BOPP/CPP films.

In a preferred embodiment, the plastic may be both biodegradable and recyclable.

The blisters (5) can be of any shape, but all the blisters (5) should be of the same shape in a chain (1) in order to form a compact concertina fold.

By compact concertina fold is meant that the repeating units of the blister chain are linked in such a way that their cavities fit into each other when stacking in an alternating way. One such embodiment is demonstrated in FIG. 4.

Ideally the cavities fit into each other by having their walls at a slight angle, preferably between 1 and 60°, more preferably less than 45°, or even less than 30°.

Each blister pack may contain one or more blisters, preferably it contains at least one blister, but for the scope of the present invention blister packs containing two or more blisters are not excluded, for example a blister pack with two blisters, one blister with a shampoo and the other with a conditioner.

The backing can be made of any known materials commercially available for forming a backing in blister packs such as paper, aluminium or plastic. The backing is preferably made of a biodegradable or recyclable material. Suitable biodegradable or recyclable material include paper or cardboard.

In a preferred embodiment, the material may be both biodegradable and recyclable.

In one embodiment, the blister and the backing are made of the same material.

In another embodiment, the blisters are made of a material running continuously along the whole chain and the backing is made of a different material to seal the cavities on alternating sides.

In yet another embodiment, the backing is made of a material running continuously along the whole chain and the blisters are made of a different material to cover the product on alternating sides.

### Foldable Regions

Between each blister pack (2), there is provided a foldable region (3) on the backing which is preferably weaker than the rest of the backing for easy folding between the packs.

The foldable region preferably comprises a line of weakness (4) along which the blister packs (2) can be separated and/or folded.

The line of weakness (4) can be continuous such as the use of a thinner or weaker material than the backing material that can be folded and/or torn. The line of weakness (4) can also be discontinuous such as scored or perforated.

In preferred embodiments, the foldable region (3) comprises a groove (6) along which the blister packs (2) can be folded. The groove may further comprise the line of weakness (4). The character of the line of weakness (4) may be according to the description of the paragraph immediately above. The groove is found particularly helpful to guide consumer to fold as well as control the manner of folding. It also ensures the cavities fold inside one another. The grooves may all be protruding in the same direction, or they may be alternating.

The chain of blister packs (1) can form a concertina fold before and after the use of the product (P) but the angle (a) between the packs vary. After the use of the product (P), the cavities fit into each other forming a compact concertina fold. Preferably, the chain of blister packs (1) form a compact concertina fold after the use of at least two products in the chain.

When the chain is in a concertina fold before the use of the product (P), the blister packs (2) are at an angle of 40° to 180° (a), preferably at least 50°, more preferably at least 60°, still more preferably at least 70°, even more preferably at least 80°, but typically not more than 160°, preferably not more than 140°, more preferably not more than 120°, still more preferably not more than 100°, even more preferably not more than 90° at the foldable region (3).

When the chain is in a compact concertina fold after the use of the product (P), the blister packs (2) are at an angle of 0° to 25° (a), preferably at least 2.5°, more preferably at least 5° more preferably at least 8°, still more preferably at least 10°, even more preferably at least 13° but typically not more than 23°, preferably not more than 20°, more preferably not more than 18°, still more preferably not more than 15° at the foldable region (3).

After the use of the product (P), the chain of opened blister packs can be stacked one above the other in a compact manner making it convenient for disposal or collection.

The method of collecting packaging material according to the present invention comprises a step of providing a chain of empty blister packs according to the present invention; followed by folding the chain to form a concertina fold wherein all the blisters (5) are of the same shape in the chain (1) such that the repeating units of the blister chain are linked in such a way that their cavities fit into each other when stacking in an alternating way.

### Product

The product (P) according to the present invention is preferably in solid or a semi solid format such as a gel to avoid any product wastage during use.

The product (P) is typically a dehydrated product that may be dissolved using a solvent before use.

The product (P) comprises less than 50% of water, preferably less than 45%, more preferably less than 40%, still more preferably less than 35%, even more preferably less than 30%, or even less than 25% or even less than 20% or even less than 15% or even less than 10% by weight of the total product composition.

The product (P) of the present invention is preferably a FMCG product; in particular, a personal care, home care or food product. Home care products may be detergent tablets (such as laundry or dishwashing detergents), cleaning composition tablets, water purification compositions. Food products may include, bouillon cubes, food concentrates, instant soups or sauces, chewing gum, instant dressings. Personal care products may include detergent compositions such shampoo, conditioner, soap (such as hand wash, face wash or body wash/shower gel), mouthwash, intimate wash, shaving gel.

Preferably the product (P) is a personal care product, which is a shampoo, conditioner or body wash/shower gel in dehydrated format.

Each blister pack may contain one or more products in a blister, preferably it contains at least one product, but for the scope of the present invention blisters containing two or more products are not excluded, for example a blister pack comprising a blister with a shampoo and a conditioner. In case of more than one product, said products may be same or different.

Each blister pack preferably provides one unit dose of the product.

### BRIEF DESCRIPTION OF THE FIGURES

FIG. 1A is a perspective view of a hanging chain of blister packs arranged in an alternating manner.

FIG. 1B is a side view of a hanging chain of blister packs arranged in an alternating manner.

FIG. 2 is a side view of a chain of unused blister packs in a concertina fold.

FIG. 3 is a side view of a chain of used blister packs falling into a compact concertina fold.

FIG. 4 is a side view of a chain of used blister packs in a compact concertina.

FIG. 5 is a side view of a chain of blister packs arranged in an alternating manner with lines of weakness and grooves. It is clear that after the use of product (P), the packs can be folded into a compact concertina form with an angle of 0° to 25° (α) at the foldable region (3).

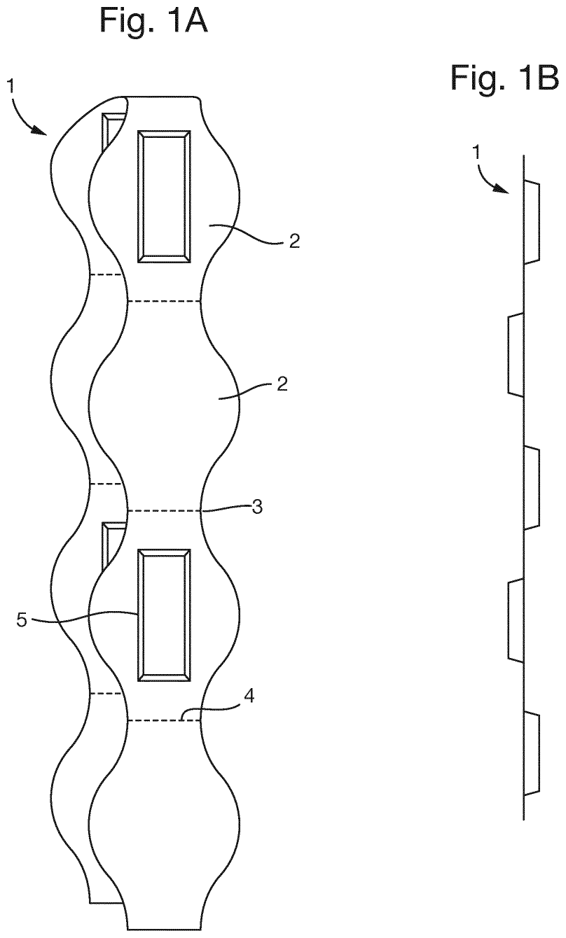

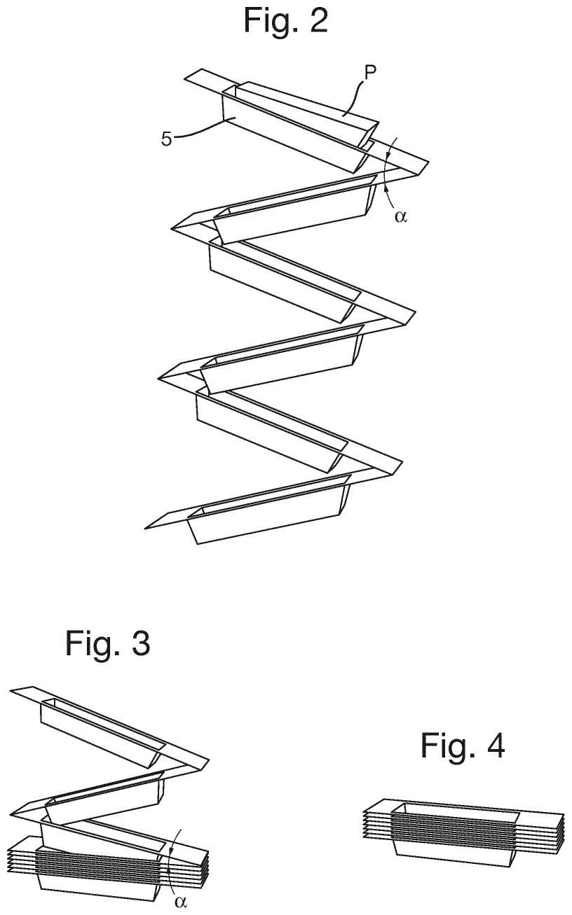

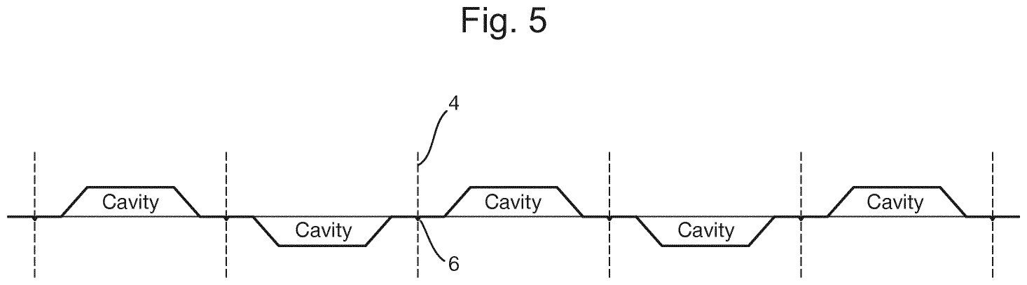

What is claimed is:

1. A method of collecting packaging material comprising a chain of blister packs characterized in that after use of a product contained in a blister, a chain of emptied blister packs forms a concertina fold, wherein all the blisters are of the same shape in the chain of blister packs such that the repeating units of the chain of blister packs are linked in such a way that their cavities fit into each other when stacking in an alternating way.

2. The method of claim 1, wherein the blister packs are arranged in an alternating manner and have foldable regions between the blister packs.

3. The method of claim 2, wherein the blister packs are at an angle of 40° to 180°, inclusive, at the foldable region in the concertina fold before the use of the product.

4. The method of claim 2, wherein the blister packs are at an angle of 0° to 25°, inclusive, at the foldable region in the compact concertina fold after the use of the product.

5. The method of claim 2 wherein the foldable region comprises a line of weakness.

6. The method of claim 1, wherein the chain of blister packs forms a compact concertina fold after the use of at least two products in the chain.

7. The method of claim 1, wherein the product comprises less than 50% of water by weight of the total product composition.

8. The method of claim 1, wherein the product is a fast moving consumer good (FMCG) product.

9. The method of claim 1, wherein the product is at least one of: a personal care, home care, or food product.

10. The method of claim 1, wherein the blisters are made of at least one of: a biodegradable plastic or a recyclable plastic.

11. The method of claim 1, wherein the blister pack has a backing made of at least one of: a biodegradable material or a recyclable material.

12. The method of claim 1, wherein the chain is a hanging chain.

13. The method of claim 1, wherein each blister pack provides one unit dose of the product.

14. A method comprising:
removing a first product contained in a first blister pack from the first blister pack, the first blister pack being part of a chain of blister packs, and the first blister pack being a first empty blister pack after the removing the first product;
removing a second product contained in a second blister pack from the second blister pack, the second blister pack being part of the chain of blister packs, and the second blister pack being a second empty blister pack after the removing the second product;
forming a concertina fold between the first empty blister pack and the second empty blister pack; and
placing one of the first empty blister pack or the second empty blister pack within the other of the first empty blister pack or the second empty blister pack.

15. The method of claim 14, wherein a first shape of the first empty blister pack is identical to a second shape of the second empty blister pack.

16. The method of claim 14, wherein the first blister pack is contiguous with the second blister pack.

17. The method of claim 14, wherein:
the chain of blister packs includes a fold line between the first blister pack and the second blister pack; and
the fold line facilitates rotation of the first blister pack relative to the second blister pack.

18. A package comprising:
a first blister pack having a first shape;
a second blister pack having a second shape that is configured to be at least partially received within the first shape; and
a fold line disposed between the first blister pack and the second blister pack and facilitating rotation of the first blister pack relative to the second blister pack.

19. The package of claim 18, wherein the first shape is identical to the second shape.

20. The package of claim 18, further comprising a plurality of concertina folds, one of the plurality of concertina folds being the fold line.
